(19) United States
(12) Patent Application Publication
(10) Pub. No.: US 2007/0115766 A1
(43) Pub. Date: May 24, 2007

(54) Optical head

(75) Inventor: Kenichi Fujita, Daito (JP)

Correspondence Address: BACON & THOMAS, PLLC, 625 SLATERS LANE, FOURTH FLOOR, ALEXANDRIA, VA, 22314, US

(73) Assignee: FUNAI Electric Co., Ltd., Daito (JP)

(21) Appl. No.: 11/598,796

(22) Filed: Nov. 14, 2006

(30) Foreign Application Priority Data
Nov. 18, 2005 (JP) 2005-333715

(51) Int. Cl. G11B 7/00

(52) U.S. Cl. 369/44.15

(57) ABSTRACT

There is provided an optical head having a simple structure not to require a lot of time and effort in production and assembling as well as capable of applying a laser beam stably to the recording layer of an optical disk. A laser light source 11, a rectangular parallelepiped laser holder 12 for press-fitting the laser light source 11 therein, an elastic holder supporting member 13 for elastically supporting the laser holder 12, and clip portions 14 for fixing a base Bs and the elastic holder supporting member 13 stably and elastically are mounted on the base Bs, and notch portions 135 are formed in the elastic holder supporting member 13.

### BACKGROUND OF THE INVENTION

1. Field of the Invention

The present invention relates to an optical head for recording and (or) reading data by applying light to an optical disk.

2. Description of the Prior Art

Recently, there are widely used apparatuses that utilize an optical disk, onto/from which videos, audios, and/or information can be recorded and (or) read by applying light, as a recording medium. CDs (Compact Disks), DVDs (Digital Versatile Disks), and the like are widely used as such an optical disk. Optical disk apparatuses that utilize such an optical disk as a recording medium to record and (or) read data onto/from the optical disk include an optical head for applying a laser beam to the recording surface of the optical disk and for detecting reflected light.

FIG. 1 is a view showing an arrangement in an optical head. As shown in FIG. 1, there are provided a laser light source 11, a mirror Mr, a collimator lens 3, an objective lens 4, a beam splitter Sp, and a light receiving element Pd. A laser beam emitted from the laser light source 11 is reflected at the mirror Mr to enter the collimator lens 3. The laser beam incident to the collimator lens 3 is output as parallel light to enter the objective lens 4. The laser beam incident to the objective lens 4 is applied to the recording surface of a Optical disk Ds.

In the case above, the laser beam is applied focusing on the recording layer of the Optical disk Ds with the optical axis thereof being perpendicular to the recording layer of the Optical disk Ds. The beam splitter Sp is a prism for transmitting a half of the incident laser beam and for reflecting the other half, adapted to guide the light reflected at the Optical disk Ds toward the light receiving element Pd. The light receiving element Pd is adapted to convert light into current and to read data based on the intensity of the light.

FIG. 6 is a perspective view of a conventional laser optical system. The laser optical system 91 is mounted on a base Bs, including a laser light source 92, a laser holder 93 in which the laser light source 92 is press-fitted, and an elastic holder supporting member 94 for supporting the laser holder 93.

The laser holder 93 here has a rectangular parallelepiped shape, though not restricted thereto, in the central part thereof being fitted the laser light source 92 detachably. The elastic holder supporting member 94 has: a rectangular bottom portion 940 to be in contact with the base Bs; a first supporting portion 941 connected perpendicularly to the bottom portion 940 and covering almost all of a side surface of the laser holder 93; a second supporting portion 942 connected perpendicularly to the bottom portion 940 and facing the first supporting portion 941 to support a part of another side surface of the laser holder 93; and clip portions 943 fitted to a side portion of the bottom portion 940 to clip the base Bs.

As shown in FIG. 6, the laser light source 92 includes power supply terminals 921 for supplying power. Supplying power through the power supply terminals 921 causes the laser light source 92 to emit a laser beam. Also, in the base Bs and elastic holder supporting member 94, there are formed through holes for passage of laser beams, though not shown in the figure.

FIG. 7 is a side view of the conventional laser optical system shown in FIG. 6. As shown in FIG. 7, the clip portions 943 of the laser optical system 91 clip and hold the base Bs. The laser holder 93 is supported by the first and second supporting portions 941 and 942 of the elastic supporting member 94 so that the bottom portion of the laser holder 93 is not brought into contact with the bottom portion of the elastic supporting member 94.

In the state above, the angle of the laser holder 93 (laser light source 92) is adjusted so that laser beams emitted from the laser light source 92 travel on a predetermined optical path. Then, adhesion is provided at contact areas between the bottom portion 940 of the elastic supporting member 94 and the base Bs, contact areas between the first supporting portion 941 and the base Bs, and contact areas between the first supporting portion 941 and the laser holder 93 using adhesive 95 so that the laser optical system 91 is fixed to the base Bs (refer to Japanese Patent Laid-Open Publication No. 2004-178626 for example).

In the case of mounting the laser light source 92 on the base Bs, it is often the case that thermosetting adhesive, which is hardened by heating, is generally used as the adhesive 95. Thermosetting adhesive can be applied and hardened easily owing to its characteristics. However, in the case of mounting the laser holder 93 using the conventional elastic supporting member 94, it is necessary to provide adhesion between the base Bs and the elastic supporting member 94 as well as between the elastic supporting member 94 and the laser holder 93, resulting in taking a lot of time and effort in assembling even if easy-to-use thermosetting adhesive may be used.

If the base Bs, laser holder 93, and elastic supporting member 94 could be joined with adhesive at one time, it would be possible to save time and effort for assembling, but the adhesion may be made unstable, resulting in a possibility of misalignment of the optical axis of laser beams.

When the optical axis of laser beams is misaligned, it is difficult to apply a laser spot obtained by converging the laser beams to an appropriate position in the data layer of the optical disk. The displacement of the laser spot may result in that data recorded on the optical disk cannot be read properly. If data recorded on the optical disk cannot be read properly, videos and/or audios may be interrupted and the worst thing that can happen is the impossibility of reproduction in, for example, a DVD player. Also, in the case of a recordable optical head, since the laser spot cannot be applied to a predetermined position, it may be difficult to record appropriate data on the optical disk and/or it may take quite a lot of time to record the data.

### SUMMARY OF THE INVENTION

Hence, it is an object of the present invention to provide an optical head having a simple structure not to require a lot of time and effort in production and assembling as well as capable of preventing the optical axis of a laser beam emitted from a laser optical system from being misaligned and therefore of reading and (or) recording data from/onto an optical disk stably.

It is another object of the present invention to provide an optical head capable of fixing a laser holder, an elastic supporting member, and a base stably with a small amount of adhesive by ensuring a large effective adhesion area with a simple structure and therefore of reducing cost in production and assembling.

In order to achieve the foregoing objects, the present invention is directed to an optical head including: a laser optical system for emitting a laser beam; a mirror for reflecting the laser beam; a collimator lens for converting the laser beam into parallel light; an objective lens for applying the laser beam to an optical disk; a beam splitter for splitting light reflected at the optical disk; and a light receiving element for receiving light, the laser optical system being mounted on a base and having a laser light source, a laser holder in which the laser light source is press-fitted, and an elastic holder supporting member for supporting the laser holder, wherein the elastic holder supporting member includes: a rectangular bottom portion to be in contact with the base; a first supporting portion connected perpendicularly to the bottom portion and covering almost all of a side surface of the laser holder; a second supporting portion connected perpendicularly to the bottom portion and facing the first supporting portion to support a part of another side surface of the laser holder; and a clip member for clipping and fixing the base, engageable convex portions adapted to be engaged with engageable recessed portions formed in each contact surface of the laser holder being formed on the first and second supporting portions, and wherein rectangular notch portions are formed on either end of a section in the first supporting portion that is connected to the bottom portion, and the length of a straight line lying between the deepest portions of the notch portions is smaller than the longitudinal length of the side surface of the laser holder that is in contact with the first supporting portion.

In order to achieve the foregoing objects, the present invention is also directed to an optical head including: a laser optical system having a laser light source, a laser holder in which the laser light source is press-fitted, and an elastic holder supporting member for supporting the laser holder; and a base for arranging the laser optical system thereon, wherein the elastic holder supporting member includes: a rectangular bottom portion to be in contact with the base; a first supporting portion connected perpendicularly to the bottom portion and covering almost all of a side surface of the laser holder; and a second supporting portion connected perpendicularly to the bottom portion and facing the first supporting portion to support a part of another side surface of the laser holder, and wherein notch portions are formed on either end of a connecting portion between the first supporting portion and the bottom portion.

In the arrangement above, the notch portions may be formed in the first supporting portion or in the bottom portion. The notch portions each may have a rectangular shape. In addition, the length of a straight line lying between the deepest portions of the notch portions may be smaller than the longitudinal length of the side surface of the laser holder that is in contact with the first supporting portion.

In accordance with the present invention, the optical head has a simple structure not to require a lot of time and effort in production and assembling, and it is possible to prevent the optical axis of a laser beam emitted from the laser optical system from being misaligned and therefore to read and (or) record data from/onto an optical disk stably.

Also, in accordance with the present invention, it is possible to fix the laser holder, elastic supporting member, and base stably with a small amount of adhesive by ensuring a large effective adhesion area with a simple structure and therefore to reduce cost in production and assembling.

### BRIEF DESCRIPTION OF THE DRAWINGS

FIG. 1 is a view showing an arrangement in an optical head;

FIG. 2 is a perspective view of a laser optical system to be used in an optical head according to the present invention;

FIG. 3 is a side view of the laser optical system shown in FIG. 2;

FIG. 4(A) is a perspective view of an elastic holder supporting member to be used in the optical head according to the present invention and FIG. 4(B) is a front view of the elastic holder supporting member shown in FIG. 4(A);

FIG. 5 is a perspective view of an elastic holder supporting member to be used in the optical head according to the present invention;

FIG. 6 is a perspective view of a conventional laser optical system; and

FIG. 7 is a side view of the conventional laser optical system shown in FIG. 6.

### DESCRIPTION OF THE PREFERRED EMBODIMENTS

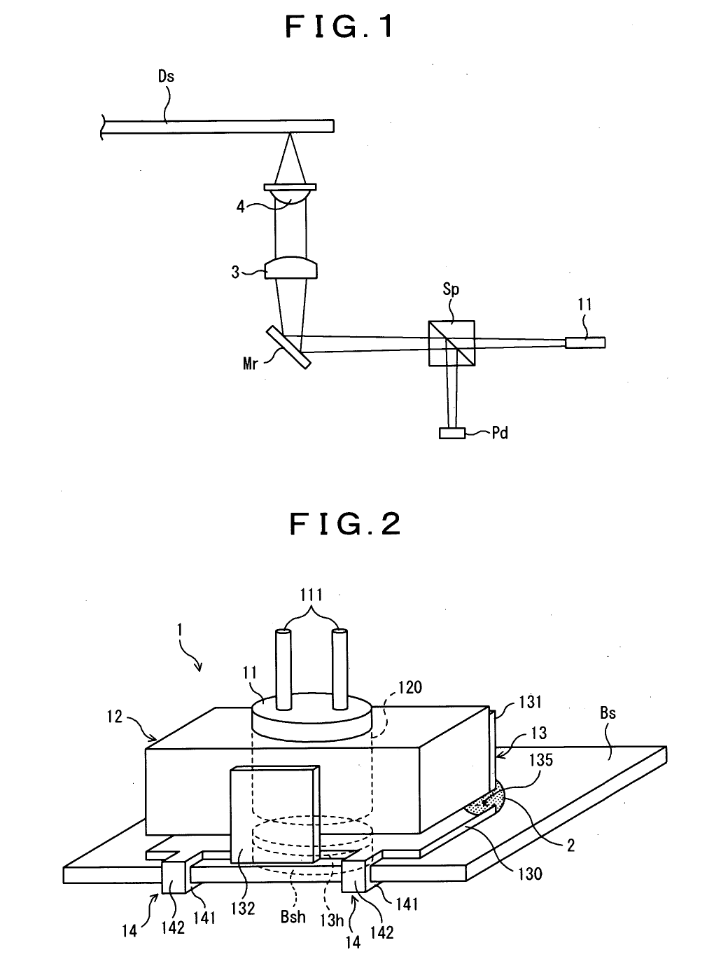

Embodiments of the present invention will hereinafter be described with reference to the accompanying drawings. FIG. 1 is a view showing an arrangement in an optical head. The optical head shown in FIG. 1 has substantially the same structure as in the conventional art. That is, there are provided a laser light source 11, a mirror Mr, a collimator lens 3, an objective lens 4, a beam splitter Sp, and a light receiving element Pd. A laser beam emitted from the laser light source 11 is reflected at the mirror Mr to enter the collimator lens 3, and then is converted into parallel light to be output from the collimator lens 3. The laser beam output from the collimator lens 3 enters the objective lens 4 to be applied to a Optical disk Ds by the objective lens 4.

In the case above, the laser beam is applied focusing on the recording layer of the Optical disk Ds with the optical axis thereof being perpendicular to the recording layer of the Optical disk Ds. The beam splitter Sp is a prism for transmitting a half of the incident laser beam and for reflecting the other half, adapted to guide the light reflected at the Optical disk Ds toward the light receiving element Pd. The light receiving element Pd is adapted to convert light into current and to read data based on the intensity of the light.

The order of applying a laser beam to the above-described optical members is not restricted thereto, but may be permuted to the extent possible. Unnecessary ones among the above-described optical components, if any, may also be removed, while necessary ones, if any, may be added.

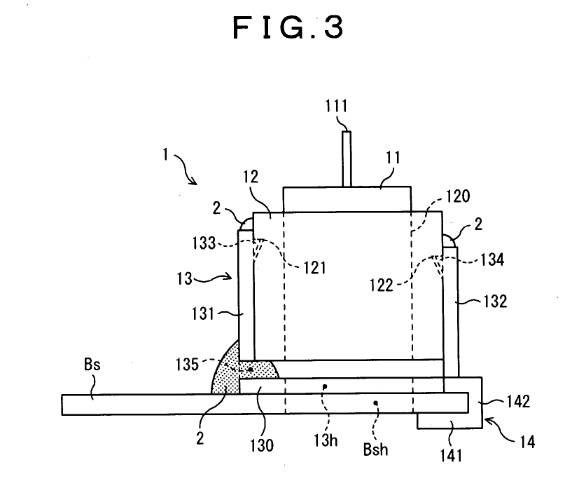

FIG. 2 is a perspective view of a laser optical system to be used in an optical head according to the present invention and FIG. 3 is a side view of the laser optical system shown in FIG. 2. The laser optical system 1 shown in FIGS. 2 and 3 is mounted on a base Bs of the optical head and has a laser light source 11, a rectangular parallelepiped laser holder 12 in which the laser light source 11 is press-fitted, an elastic holder supporting member 13 for elastically supporting the laser holder 12, and clip portions 14 for fixing the base Bs and the elastic holder supporting member 13 stably and elastically. In the base Bs, there is formed a through hole Bsh for passage of laser beams.

The laser holder 12 has a press-fit hole 120 for press-fitting the laser light source 11 therein. The press-fit hole 120 is a through hole, and laser beams are to be emitted from the side opposite to that through which the laser light source 11 is press-fitted. The laser light source 11 has power supply terminals 111, and supplying power to the terminals 111 causes a laser beam to be emitted. First engageable recessed portions 121 adapted to be engaged with first engageable convex portions 133 to be described hereinafter are formed at portions in the laser holder 12 where to be in contact with a first supporting portion 131 to be described hereinafter. Also, second engageable recessed portions 122 adapted to be engaged with second engageable convex portions 134 to be described hereinafter are formed at portions where to be in contact with a second supporting portion 132 to be described hereinafter (refer to FIG. 3).

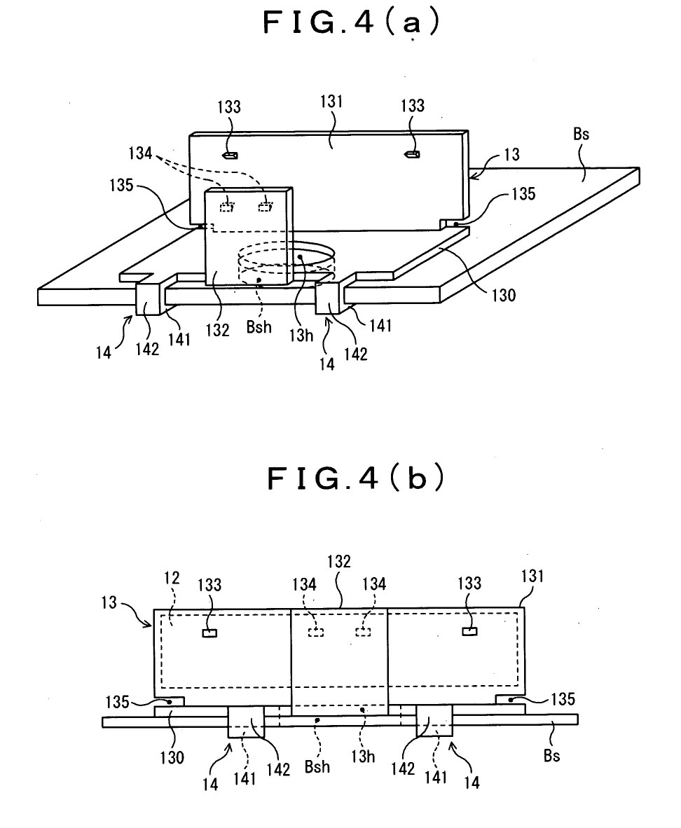

FIG. 4(A) is a perspective view of an elastic holder supporting member to be used in the laser optical system in the optical head according to the present invention and FIG. 4(B) is a front view of the elastic holder supporting member shown in FIG. 4(A). As shown in FIG. 4, the elastic holder supporting member 13 includes: a rectangular bottom portion 130; a first supporting portion 131 connected perpendicularly to the bottom portion 130 and covering almost all of a side surface of the laser holder 12; and a second supporting portion 132 connected perpendicularly to the bottom portion 130 and facing the first supporting portion 131 to support a part of another side surface of the laser holder 12. In the bottom portion 130, there is formed a through hole 13h for passage of laser beams.

The first and second supporting portions 131 and 132 can be deformed elastically and therefore can press the laser holder 12 elastically. The first engageable convex portions 133 adapted to be engaged with the first engageable recessed portions 121 are formed on the inside surface of the first supporting portion 131, while the second engageable convex portions 134 adapted to be engaged with the second engageable recessed portions 122 are formed on the inside surface of the second supporting portion 132.

As shown in FIGS. 4(A) and 4(B), rectangular notch portions 135 are provided on either end of a section in the first supporting portion 131 that is connected to the bottom portion 130. The distance L1 between the notch portions 135 on either end is made smaller than the length L2 of the laser holder 12.

The clip portions 14 are formed integrally with the bottom portion 130 of the elastic holder supporting member 13 and are arranged on either side of the second supporting portion 132, though not restricted thereto. The clip portions 14 each have a first latch portion 141 and a connecting portion 142 for connecting the first latch portion 141 and the bottom portion 130. The first latch portion 141 is adapted to extend around to the side opposite to that on which the base Bs is in contact with the bottom portion 130 and to press the base Bs elastically to prevent the laser optical system 1 from being separated from the base Bs. The first latch portion 141 and connecting portion 142 can be deformed elastically and therefore can support the base Bs elastically, even if the thickness of the base Bs may be changed, as long as the change is within a predetermined range.

When the laser holder 12 is arranged between the first and second supporting portions 131 and 132 of the elastic holder supporting member 13 and the first and second engageable recessed portions 121 and 122 are engaged, respectively, with the first and second engageable convex portions 133 and 134, the elastic holder supporting member 13 supports the laser holder 12. In this case, the bottom surface of the laser holder 12 and the bottom portion 130 of the elastic holder supporting member 13 are not in contact with each other.

The laser holder 12 is mounted in such a manner that laser beams emitted from the laser light source 11 pass through the through hole 13h in the elastic holder supporting member 13. Also, the elastic holder supporting member 13 is arranged in such a manner that the through hole 13h is overlapped with the center axis of the through hole Bsh in the base Bs. Laser beams are to be emitted through the through hole 13h in the elastic holder supporting member 13 and the through hole Bsh in the base Bs.

As shown in FIGS. 2 and 3, the elastic holder supporting member 13 is fixed to the base Bs using adhesive 2. The adhesive 2 is put into the notch portions 135 formed in a section in the first supporting portion 131 of the elastic holder supporting member 13 that is connected to the bottom portion 130. As shown in FIG. 3, the adhesive 2 is put into the notch portions 135 to be applied to the base Bs, laser holder 12, bottom portion 130, and first supporting portion 131, so that these components can be fixed to each other.

Although the end portions of the first supporting portion 131 may be entirely the notch portions 135, it is preferable that the notch portions 135 be formed in the vicinity of sections (lower parts) in the end portions of the first supporting portion 131 that are connected to the bottom portion 130 as shown in FIG. 4, because adhesive can be applied to the rest areas in the end portions of the first supporting portion 131, in which the notch portions 135 are not formed, to achieve an increased effective adhesion area. Although the notch portions 135 each have, for example, a rectangular shape in the description of the present embodiment, the shape is not restricted thereto, and it is possible to widely employ shapes with which the length between the deepest portions of the notch portions 135 is made smaller than the length of the laser holder 12 and whereby the base Bs, laser holder 12, bottom portion 130, and first supporting portion 131 can be fixed to each other at one injection of adhesive.

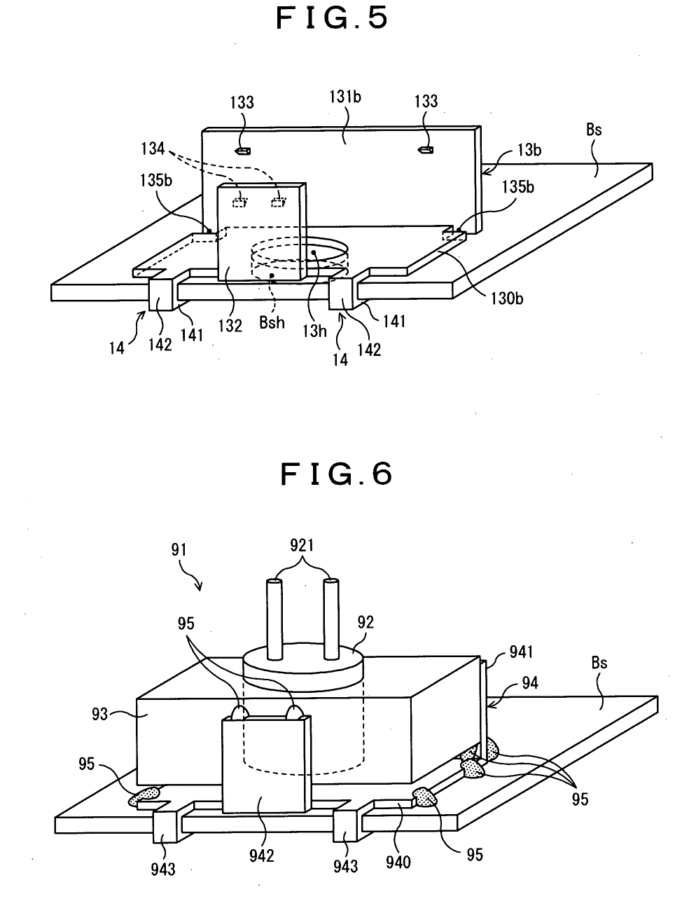

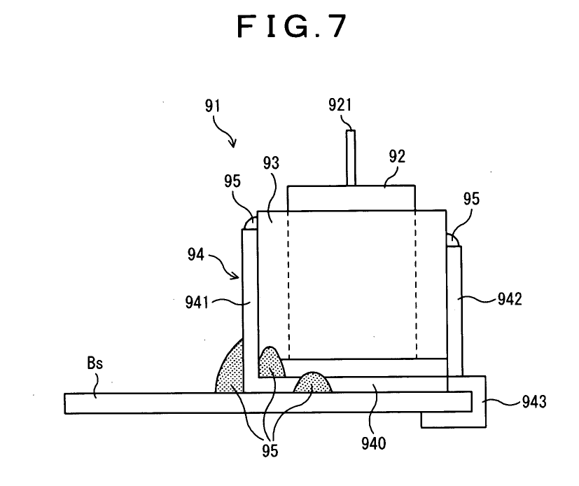

FIG. 5 is a perspective view of another elastic holder supporting member to be used in the laser optical system in the optical head according to the present invention. In the elastic holder supporting member 13b shown in FIG. 5, notch portions 135b are provided in the bottom portion 130b. Also, since the rest has substantially the same arrangement as the elastic supporting member 13, substantially identical members are designated by the same reference numerals.

Forming the notch portions 135b in the bottom portion 130b allows the amount of inflow adhesive 2 to be applied to the first supporting portion 131b to be reduced. Further, although the effective adhesion area is reduced because the adhesive 2 is not applied to the side of the first supporting portion 131b opposite to the laser holder 12, it is possible to prevent the adhesive 2 from being applied to the side of the first supporting portion 131b opposite to the laser holder 12.

Although the notch portions 135 and 135b each have, for example, a rectangular shape in the descriptions of the above-described embodiments, the shape is not restricted thereto, and it is possible to widely employ shapes with which the length between the deepest portions of the notch portions 135 and 135b is made smaller than the length of the laser holder 12 and whereby the base Bs, laser holder 12, bottom portion 130, and first supporting portion 131 can be fixed to each other at one injection of adhesive.

The adhesive 2 used in the above-described embodiments is thermosetting adhesive, which may come away by heat and/or moisture, etc. even after adhesion. Even when the adhesive may come away or may be loosened, the laser optical system 1 cannot be separated from the base Bs because the clip portions 14 are installed and it is therefore possible to prevent misalignment of the optical axis, whereby laser beams can be emitted stably and thereby the optical head can be operated stably. Although the adhesive is, for example, thermosetting one in the descriptions here, even another type of adhesive may be used in the same way.

The optical head according to the present invention is applicable to optical disk apparatuses for reading information by applying a laser beam to an optical disk such as DVD, CD, or LD and/or for recording information onto a writable optical disk.

1. An optical head comprising: a laser optical system for emitting a laser beam; a mirror for reflecting said laser beam; a collimator lens for converting said laser beam into parallel light; an objective lens for applying said laser beam to an optical disk; a beam splitter for splitting light reflected at said optical disk; a light receiving element for receiving light; and a base for arranging optical members thereon,
said laser optical system being mounted on said base and having a laser light source, a rectangular parallelepiped laser holder in which said laser light source is press-fitted, and an elastic holder supporting member for supporting said laser holder, wherein
said elastic holder supporting member comprises: a rectangular bottom portion to be in contact with said base; a first supporting portion connected perpendicularly to said bottom portion and covering as well as supporting almost all of a side surface of said laser holder; a second supporting portion connected perpendicularly to said bottom portion and facing said first supporting portion to support the side surface of said laser holder opposite to said side surface supported by said first supporting portion; and a clip member formed integrally with said bottom portion and facing said bottom portion to clip and fix said base,
engageable convex portions adapted to be engaged with engageable recessed portions formed in each contact surface of said laser holder being formed on said first and second supporting portions, and wherein
rectangular notch portions are formed on either end of a section in said first supporting portion that is connected to said bottom portion, and adhesive can be applied to said base, laser holder, bottom portion, and first supporting portion by putting said adhesive into said notch portions.

2. An optical head comprising: a laser optical system for emitting a laser beam; a mirror for reflecting said laser beam; a collimator lens for converting said laser beam into parallel light; an objective lens for applying said laser beam to an optical disk; a beam splitter for splitting light reflected at said optical disk; and a light receiving element for receiving light,
said laser optical system being mounted on a base and having a laser light source, a rectangular parallelepiped laser holder in which said laser light source is press-fitted, and an elastic holder supporting member for supporting said laser holder, wherein
said elastic holder supporting member comprises: a rectangular bottom portion to be in contact with said base; a first supporting portion connected perpendicularly to said bottom portion and covering as well as supporting almost all of a side surface of said laser holder; a second supporting portion connected perpendicularly to said bottom portion and facing said first supporting portion to support a part of the side surface of said laser holder opposite to said side surface supported by said first supporting portion; and a clip member formed integrally with said bottom portion and facing said bottom portion to clip and fix said base,
engageable convex portions adapted to be engaged with engageable recessed portions formed in each contact surface of said laser holder being formed on said first and second supporting portions, and wherein
rectangular notch portions are formed on either end of a section in said first supporting portion that is connected to said bottom portion, and the length of a straight line lying between the deepest portions of said notch portions is smaller than the longitudinal length of the side surface of said laser holder that is in contact with said first supporting portion.

3. An optical head comprising: a laser optical system having a laser light source, a rectangular parallelepiped laser holder in which said laser light source is press-fitted, and an elastic holder supporting member for supporting said laser holder; and a base for arranging said laser optical system thereon, wherein
said elastic holder supporting member comprises: a rectangular bottom portion to be in contact with said base; a first supporting portion connected perpendicularly to said bottom portion and covering as well as supporting almost all of a side surface of said laser holder; and a second supporting portion connected perpendicularly to said bottom portion and facing said first supporting portion to support a part of the side surface of said laser holder opposite to said side surface supported by said first supporting portion, and wherein
notch portions are formed on either end of a connecting portion between said first supporting portion and said bottom portion.

4. The optical head according to claim 3, wherein said notch portions are formed in said first supporting portion.

5. The optical head according to claim 3, wherein said notch portions are formed in said bottom portion.

6. The optical head according to claim 3, wherein the length of a straight line lying between the deepest portions of said notch portions is smaller than the longitudinal length of the side surface of said laser holder that is in contact with said first supporting portion.

7. The optical head according to claim 3, wherein said notch portions each have a rectangular shape.

8. The optical head according to claim 4, wherein the length of a straight line lying between the deepest portions of said notch portions is smaller than the longitudinal length of the side surface of said laser holder that is in contact with said first supporting portion.

9. The optical head according to claim 5, wherein the length of a straight line lying between the deepest portions of said notch portions is smaller than the longitudinal length of the side surface of said laser holder that is in contact with said first supporting portion.

10. The optical head according to claim 4, wherein said notch portions each have a rectangular shape.

11. The optical head according to claim 5, wherein said notch portions each have a rectangular shape.

12. The optical head according to claim 6, wherein said notch portions each have a rectangular shape.
